(19) United States
(12) Patent Application Publication
(10) Pub. No.: US 2010/0013770 A1
(43) Pub. Date: Jan. 21, 2010

(54) Computer input device

(75) Inventor: Tung-Ho Tai, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/285,263

(22) Filed: Oct. 1, 2008

(30) Foreign Application Priority Data
Jul. 17, 2008 (TW) 097127238

(51) Int. Cl. G09G 5/08

(52) U.S. Cl. 345/163

(57) ABSTRACT

A computer input device including a top shell and a bottom shell is described. The top shell is manufactured in an integral and inseparable manner. The top shell is formed with an annular trench, so as to form movable members with pressing ends. The pressing ends contact an electronic circuit device installed on the bottom shell and may be reciprocally moved on the electronic circuit device.

### CROSS-REFERENCE TO RELATED APPLICATIONS

This non-provisional application claims priority under 35 U.S.C. §119(a) on Patent Application No(s). 097127238 filed in Taiwan, R.O.C. on Jul. 17, 2008 the entire contents of which are hereby incorporated by reference.

### BACKGROUND OF THE INVENTION

1. Field of the Invention

The present invention relates to a computer input device, and more particularly to a mouse for implementing input operations.

2. Related Art

Nowadays, with the rapid development of information technology, peripheral equipments of electronic products associated with a computer are increased day by day. Therefore, those manufactures must enhance their speeds both in manufacturing and assembling products, so as to meet the supply demands on the consumer market. Taking a mouse as an example, all mouse structures currently available on the market are designed in three pieces. A mouse case is formed by combining a bottom shell, an upper cover, and a dome sheet. A complete case is constituted by combining the upper cover with the bottom shell and then fastening the dome sheet to the upper cover. The dome sheet and the upper cover have different curvatures when they are configured. After the case of the mouse has been assembled, by utilizing the difference between the curvatures, the dome sheet is provided with an operating stroke for being pressed, so as to realize a click function of the mouse.

Therefore, during the assembly of the conventional mouse case, the upper cover and the dome sheet are required to have different curvatures when they are matched with each other, so that the dome sheet is enabled to realize a click function. In order to achieve this purpose, different molds need to be developed for the upper cover and the dome sheet respectively in the manufacturing process, which not only increases the cost for developing the molds, but also consumes more raw materials required during production, so that the overall production cost is increased. Meanwhile, it further needs to confirm whether the upper cover and the dome sheet are fastened together in a matching way. As a result, the assembly speed cannot be raised, thereby influencing the production efficiency of the products.

As known from the above descriptions, if the upper cover and the dome sheet can be combined properly, the components of the mouse case structure can be reduced and simplified, thereby effectively enhancing the production efficiency of the products, and saving the cost for developing the molds, thereby reducing the manufacturing cost.

### SUMMARY OF THE INVENTION

In view of the above problems, the present invention is directed to a computer input device, which is constituted by a top shell and a bottom shell, thereby solving the problems that the conventional computer input device is inconveniently assembled and has excessively high production and development costs.

The computer input device of the present invention includes: a bottom shell, for accommodating an electronic circuit device; and a top shell, integrally and inseparably formed and matched with the bottom shell, and combined on the bottom shell. Meanwhile, at least one annular trench and at least one movable member with a pressing end are integrally and inseparably formed along a front edge of the top shell. At least one micro-switch for being pressed is under the bottom side of the movable member.

In the computer input device of the present invention, through at least one annular trench and at least one movable member with the pressing end formed on the top shell in an integral and inseparable manner, the pressing end on the movable member is provided with an operating stroke of moving reciprocally between the top shell and the bottom shell by utilizing the flexible feature of the material itself, such that the pressing end contacts and presses the micro-switch located under the bottom side of the movable member, thereby simplifying the components for constituting the case of the computer input device.

### BRIEF DESCRIPTION OF THE DRAWINGS

The present invention will become more fully understood from the detailed description given herein below for illustration only, and thus is not limitative of the present invention, and wherein:

FIG. 1 is a schematic three-dimensional exploded view of an embodiment of the present invention;

FIG. 2 is a schematic top view of a top shell in the embodiment of the present invention;

FIG. 3 is a schematic bottom view of the top shell in the embodiment of the present invention;

FIG. 4 is a schematic three-dimensional assembled view of the embodiment of the present invention;

FIG. 5A is a schematic sectional view of bumps at pressing ends contacting micro-switches according to the embodiment of the present invention; and

FIG. 5B is a schematic view of an operation of pressing the pressing ends of movable members according to the embodiment of the present invention.

### DETAILED DESCRIPTION OF THE INVENTION

The computer input device disclosed in the present invention includes, but is not limit to, a mouse, a trackball, or other peripheral input equipments of a computer.

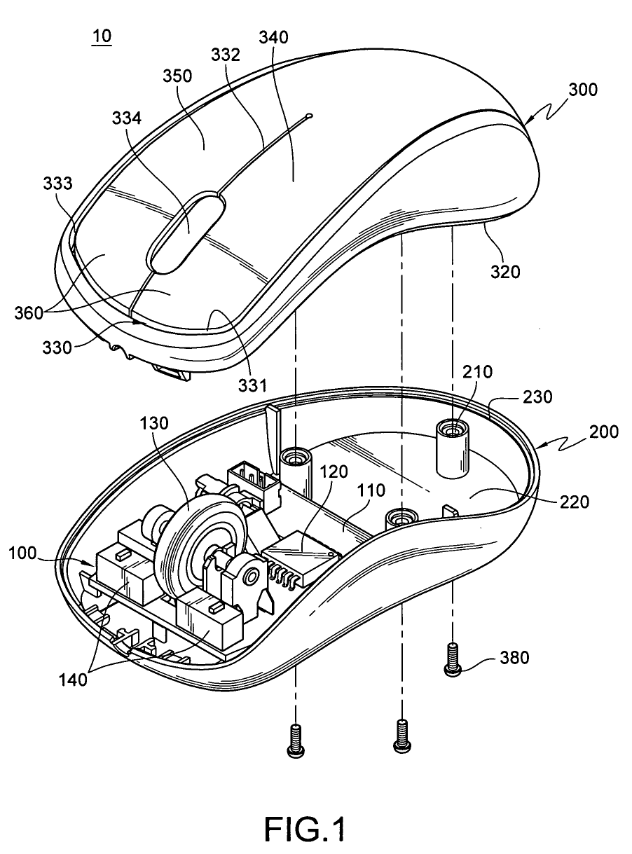

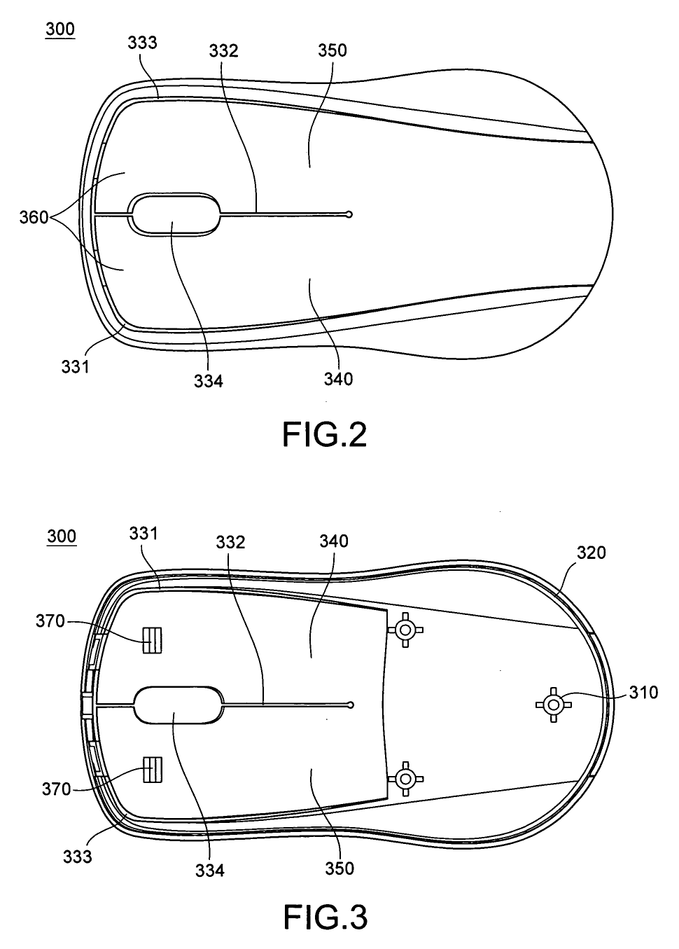

FIG. 1 is a schematic three-dimensional exploded view of an embodiment of the present invention. Referring to FIG. 1, a computer input device 10 provided in the present invention includes a bottom shell 200 for accommodating an electronic circuit device 100 and a top shell 300. The bottom shell 200 has a fastening portion 210 and an accommodation space 220 and is further formed with a groove 230 along a side edge thereof. Referring to FIGS. 2 and 3, the top shell 300 has a fixing pillar 310 corresponding to the fastening portion 210 of the bottom shell 200 and is formed with a guiding flake 320 matching with the groove 230 of the bottom shell 200 along a side edge of the top shell 300. The top shell 300 is manufactured in an integral and inseparable manner. An annular trench 330 is formed along a front edge of the top shell 300. The annular trench 330 has a first side trench 331, a central trench 332, and a second side trench 333. The first side trench 331 and the central trench 332 form a first movable member 340, and the central trench 332 and the second side trench 333 form a second movable member 350. Each of the movable members 340 and 350 has a pressing end 360, and a bump 370 is disposed on the pressing end 360. In addition, the central trench 332 has a hole 334 for accommodating a Z-axis control device 130 such as a scroll wheel, a micro rocker, a key pad, and a touch device therein. Particularly, the annular trench 330 is formed along the front edge of the top shell 300. The annular trench 330 and the central trench 332 are disposed in an approximately T-shaped configuration. The first movable member 340 is located between the firest side trench 331 and the central trench 332. The second movable member 350 is located between the central trench 332 and the second side trench 333. The hole is located between the central trench 332 and the two movable members 340 and 350, so as to accommodate the Z-axis control device 130 therein.

The above electronic circuit device 100 is disposed in the accommodation space 220 of the bottom shell 200 and includes a printed circuit board 110 disposed on the bottom shell 200, and a coordinate detector 120, a Z-axis control device 130, and a plurality of micro-switches 140 sequentially disposed on the printed circuit board 110.

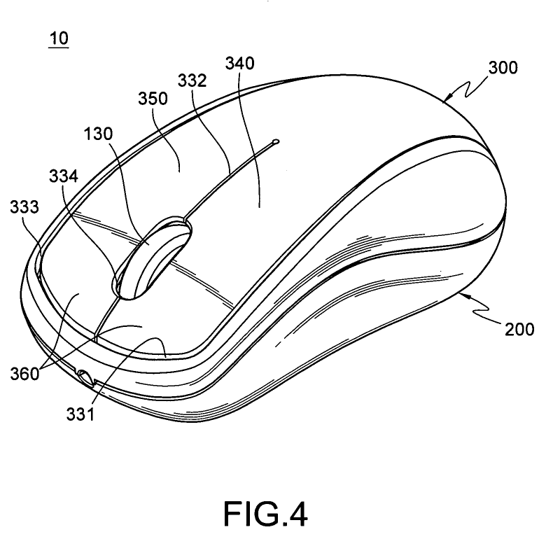

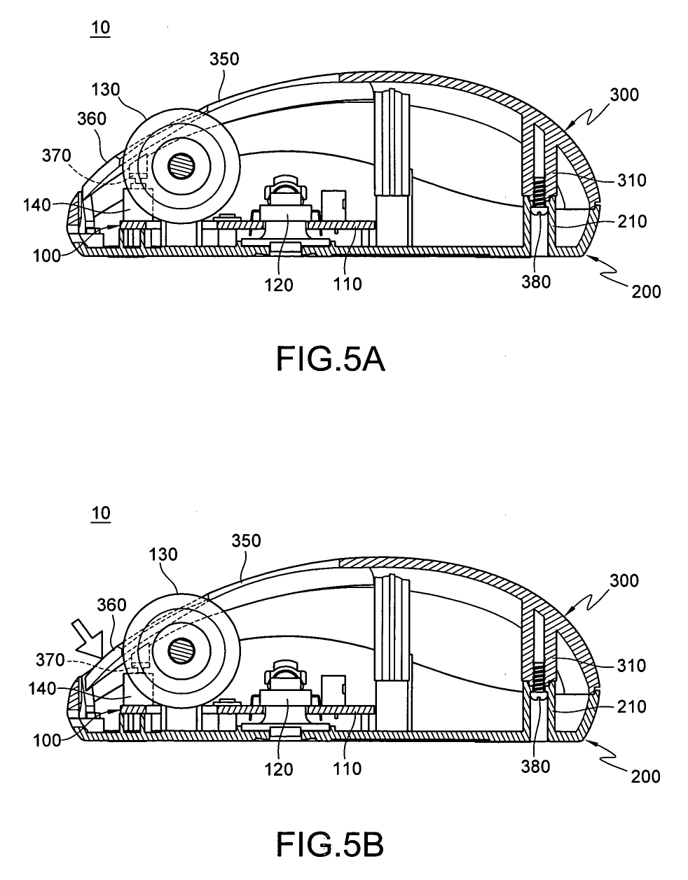

FIG. 4 is a schematic three-dimensional assembled view of the embodiment of the present invention. Referring to FIG. 4, when the top shell 300 is combined with the bottom shell 200, the top shell 300 exactly covers the bottom shell 200. The guiding flake 320 along the side edge of the top shell 300 is embedded in the groove 230 along the side edge of the bottom shell 200. The fixing pillar 310 of the top shell 300 is fastened to the fastening portion 210 of the bottom shell 200 and they are secured together through a plurality of screws 380. Therefore, the top shell 300 is stably disposed on the bottom shell 200. At this time, the Z-axis control device 130 located on the electronic circuit device 100 is exactly placed in the hole 334 of the central trench 332 of the top shell 300 and is partly exposed out of the top shell 300 for being operated by a user. The pressing ends 360 of the two movable members 340 and 350 are in a suspension state with respect to the micro-switches 140. The suspension state thereof offers a stroke for moving reciprocally between the two movable members 340 and 350 and the electronic circuit device 100. During the operation, a user presses the pressing ends 360 of the two movable members 340 and 350, such that the bumps 370 contacting the micro-switches 140 are reciprocally moved on the micro-switches 140 by utilizing a flexible feature of the material, so as to achieve an operating motion (as shown in FIGS. 5A and 5B).

The case structure of the computer input device in the present invention is constituted by a top shell and a bottom shell. The top shell is formed in an integral and inseparable manner and includes the annular trench (the side trenches and the central trench), the hole, and the like, which are also formed in an integral and inseparable manner, so as to form two movable members. Since the pressing ends on the movable members can reciprocally move in the operating stroke between the movable members and the electronic circuit device by utilizing the flexible feature of the material itself, the user can trigger the micro-switches on the electronic circuit device by the pressing ends, thereby achieving the purpose of operating the computer input device.

Compared with the prior art, after the upper cover and the dome sheet of the case structure are simplified into a single top shell element, the computer input device of the present invention still maintains the original pressing operation function. Meanwhile, the assembly speed of the computer input device is correspondingly increased through simplifying the components of the case. Furthermore, the overall manufacturing cost is reduced, since no additional molds need to be developed for manufacturing other components of the case.

What is claimed is:

1. A computer input device, comprising:
a bottom shell, for accommodating an electronic circuit device, and
a top shell, matching with the bottom shell in an integral and inseparable manner, so as to be combined on the bottom shell, wherein at least one annular trench and at least one movable member with a pressing end are integrally and inseparably formed on the top shell along a front edge thereof, and at least one micro-switch for being pressed is under the bottom side of the movable member.

2. The computer input device according to claim 1, wherein the annular trench comprises a first side trench, a central trench, and a second side trench, the first side trench and the central trench form a movable member, and the second side trench and the central trench form another movable member.

3. The computer input device according to claim 2, wherein the central trench further has a hole to accommodate a Z-axis control device.

4. A computer input device, comprising:
a case, for accommodating an electronic circuit device therein, wherein the case further comprises a bottom shell and an integrally formed top shell;
wherein the top shell further has two integral and inseparable movable members, a hole is formed between the two movable members to accommodate a Z-axis control device therein, a central trench penetrating through the hole is formed between the two movable members integrally and inseparably, an annular trench is formed integrally and inseparably and disposed at a top end of the central trench, and side trenches are formed integrally and inseparably and respectively disposed at each side of the annular trench.

5. A computer input device, comprising:
a bottom shell and an integral and inseparable top shell; wherein an annular trench is formed integrally and inseparably between a front edge of the top shell and the top shell along the front edge of the top shell, the annular trench is connected to an integral and inseparable central trench into an approximately T-shaped configuration, a movable member is integrally and inseparably formed between the central trench and the annular trench, and a hole is formed integrally and inseparably between the central trench and the movable member to accommodate a Z-axis control device therein.
